(19) United States
(12) Patent Application Publication
(10) Pub. No.: US 2026/0015992 A1
(43) Pub. Date: Jan. 15, 2026

(54) WIND POWER PLANT AND CONTROL METHOD THEREOF

(71) Applicant: WINDFIN B.V., Leimuiden (NL)

(72) Inventors: Paul Thaler, Leimuiden (NL); Federica Baretti, Leimuiden (NL); Peter Weichbold, Leimuiden (NL); Jürgen Walter, Leimuiden (NL)

(21) Appl. No.: 19/139,776

(22) PCT Filed: Dec. 19, 2023
(86) PCT No.: PCT/IB2023/062934

§ 371 Date: Jun. 16, 2025

(30) Foreign Application Priority Data
Dec. 22, 2022 (IT) 102022000026547

(51) Int. Cl. F03D 7/02

(52) U.S. Cl. CPC F03D 7/0284; F03D 7/0208; F03D 7/0224; F05B 2260/8211; F05B 2270/1077; F05B 2270/321; F05B 2270/328; F05B 2270/337

(57) ABSTRACT

Method for controlling a wind power plant for generating and delivering electrical energy to an electrical grid (2), the wind power plant (1) comprising a wind turbine (3) configured to be selectively connected to the electrical grid (2), the method comprising controlling the wind turbine (3) among a plurality of operational modes on the basis of different weather conditions.

### CROSS-REFERENCE TO RELATED APPLICATIONS

This Patent application claims priority from Italian Patent Application No. 102022000026547 filed on Dec. 22, 2022, the entire disclosure of which is incorporated herein by reference.

### TECHNICAL FIELD

The present invention relates to a wind power plant for generating and delivering electrical energy to an electrical grid, and to a method for controlling such plant.

### BACKGROUND ART

As is known, a wind power plant for generating and delivering electrical energy to an electrical grid comprises a wind turbine normally connected to the electrical grid.

Typically, the wind turbine is positioned in locations exposed to the wind, and comprises a support structure and a plurality of blades.

The positioning, shape and dimensions of the wind turbine are also designed to maximise wind exposure. However, this implies that the wind turbine is also exposed to dangerous weather conditions, for example due to cyclones, with consequent risks for its operation in such conditions.

### DISCLOSURE OF THE INVENTION

A purpose of the present invention is to provide a method for controlling a wind power plant, which allows to overcome the above problems.

The aforementioned purpose is achieved by a method according to claim 1.

Since the operational modes depend on different weather conditions, it is possible to control the wind turbine on the basis of different weather conditions, thus reducing the risks for the operation of the wind turbine in dangerous weather conditions, for example due to cyclones.

In particular, in a first operational mode the wind turbine is connected to the electrical grid, and in a second operational mode the wind turbine is connected to an emergency power supply system of the wind power plant.

Therefore, the wind turbine can operate normally in the first operational mode, delivering electrical energy to the electrical grid, and can operate in the second operational mode wherein, thanks to the emergency power supply system, the operation of emergency systems is guaranteed even in emergency conditions, for example due to dangerous weather the conditions and wherein no voltage is present on t electrical grid.

In particular, thanks to the emergency power supply system, it is possible to guarantee the operation of sensors and actuators configured to control the wind turbine in a safe position in the second operational mode, for example in the presence of a cyclone.

Therefore, the emergency power supply system can act as a backup system.

The present invention further relates to a wind power plant according to claim 16.

### BRIEF DESCRIPTION OF THE DRAWINGS

For a better understanding of the present invention, a preferred embodiment is described hereinafter, by way of non-limiting example and with reference to the accompanying drawings, wherein:

FIG. 1 is a block diagram of a wind power plant according to the present invention;

FIG. 2 is a side elevational view, with parts removed and parts in section, of a wind turbine of the wind power plant according to the present invention;

FIG. 3 is a block diagram of components of the wind turbine of FIG. 2; and

FIG. 4 is a flowchart of a method according to the present invention.

### DETAILED DESCRIPTION OF THE INVENTION

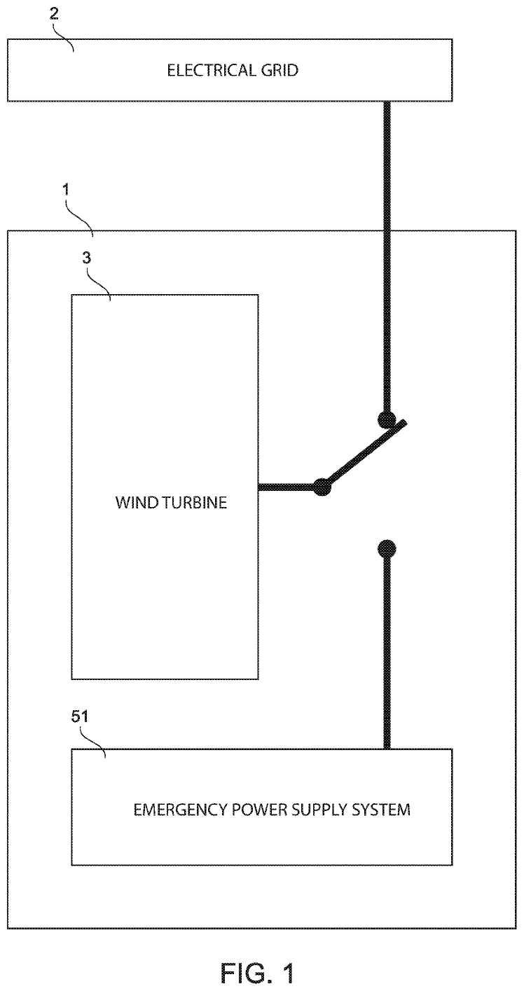

With reference to FIG. 1, there is indicated by 1 a wind power plant according to the present invention.

The wind power plant 1 is configured to generate and deliver electrical energy to an electrical grid 2, and comprises a wind turbine 3 configured to be selectively connected to the electrical grid 2.

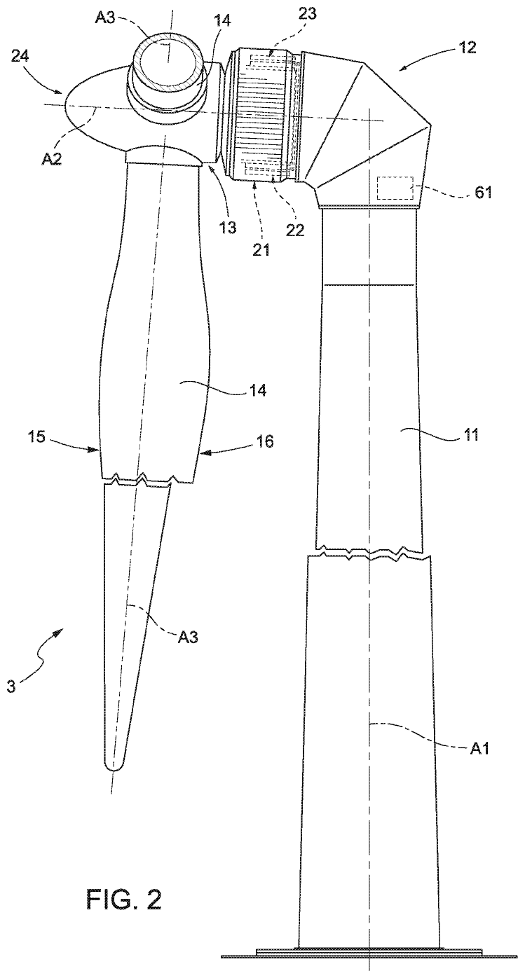

In particular, the wind turbine 3 (FIG. 2) comprises a support structure 11, a nacelle 12 carried by the support structure 11 and rotatable with respect to the support structure 11 about an axis A1, a hub 13 carried by the nacelle 12 and rotatable with respect to the nacelle 12 about an axis A2, and a plurality of blades 14 coupled to the hub 13 and pivotable about respective axes A3.

Conveniently, each blade 14 has a leading edge 15, i.e. the set of points geometrically more advanced of the airfoils of the blade 14, and a trailing edge 16, i.e. the set of points geometrically more backward of the airfoils of the blade 14.

In the depicted but non-limiting embodiment of the present invention, the axis A1 is substantially vertical, the axis A2 is inclined with respect to the axis A1, and the axes A3 are substantially orthogonal to the axis A2.

The wind turbine 3 further comprises an electrical machine 21.

In particular, the electrical machine 21 comprises a stator 22, preferably annular; and a rotor 23, preferably annular, coupled to the stator 22 magnetically and mechanically rotatably about the axis A2 via a bearing assembly (not illustrated). Therefore, in a preferred but non-limiting embodiment of the present invention, the electrical machine 21 is an electrical generator, preferably annular, configured produce to electrical energy, transforming mechanical energy into electrical energy, and to deliver it to the electrical grid 2.

Preferably, the hub 13 is fixed directly to the rotor 23 to transfer the wind-induced rotary motion to the rotor 23 itself, and preferably the nacelle 12 is fixed to the support structure 11, rotatably about the axis A1, to direct the hub 13 and the plurality of blades 14 downwind, i.e. in a normal operating position of the wind turbine 3.

Conveniently, the hub 13, the plurality of blades 14 and the rotor 23 define a rotating assembly 24 partially housed inside the nacelle 12. In particular, the rotor 23 is housed inside the nacelle 12 and is supported only by the bearing assembly arranged at the hub 13.

Conveniently, the wind turbine 3 further comprises a plurality of sensors.

Preferably, the wind turbine 3 comprises a plurality of pitch sensors 31 configured to detect rotations of the respective blades 14 about the respective axes A3.

Preferably, the wind turbine 3 comprises a yaw sensor 32 configured to detect rotations of the nacelle 12 about the axis A1.

Preferably, the wind turbine 3 comprises a sensor configured to detect rotations of the hub 13 about the axis A2.

Preferably, the wind turbine 3 comprises a sensor configured to detect the presence of voltage on the electrical grid 2.

Preferably, the wind turbine 3 comprises a sensor (anemometer) configured to detect the wind speed and/or pressure.

Conveniently, the wind turbine 3 further comprises a plurality of actuators.

Preferably, the wind turbine 3 comprises pitch actuators 41 configured to modify the angle of rotation of each blade 14 about the respective axis A3. In particular, the pitch actuators 41 comprise pitch drives and locking means comprising pitch brakes.

Preferably, the wind turbine 3 comprises yaw actuators 42 configured to modify the angle of rotation of the nacelle 12 about the axis A1. In particular, the yaw actuators 42 comprise yaw drives and locking means comprising yaw brakes.

The wind power plant 1 (FIG. 1) further comprises an emergency power supply system 51 configured to power the wind turbine 3.

In particular, the wind turbine 3 is configured to be selectively connected to the emergency power supply system 51, which comprises an engine-generator configured to power the wind turbine 3.

Preferably, the engine-generator comprises an internal combustion engine, for example a diesel engine.

The wind power plant 1 further comprises a control unit 61 configured to control the wind turbine 3 among a plurality of operational modes on the basis of different weather conditions.

In other words, at a given time instant, the wind turbine 3 is in an operational mode selected from the plurality of operational modes, which depend on different weather conditions. Therefore, mutually different operational modes imply mutually different weather conditions.

Conveniently, the weather conditions affecting the operational modes of the wind turbine 3 relate to weather phenomena of interest to the wind turbine 3. For example, they concern cyclones, which comprise tropical cyclones or typhoons (which in turn comprise tropical depressions, tropical storms, hurricanes), extratropical cyclones, mesocyclones.

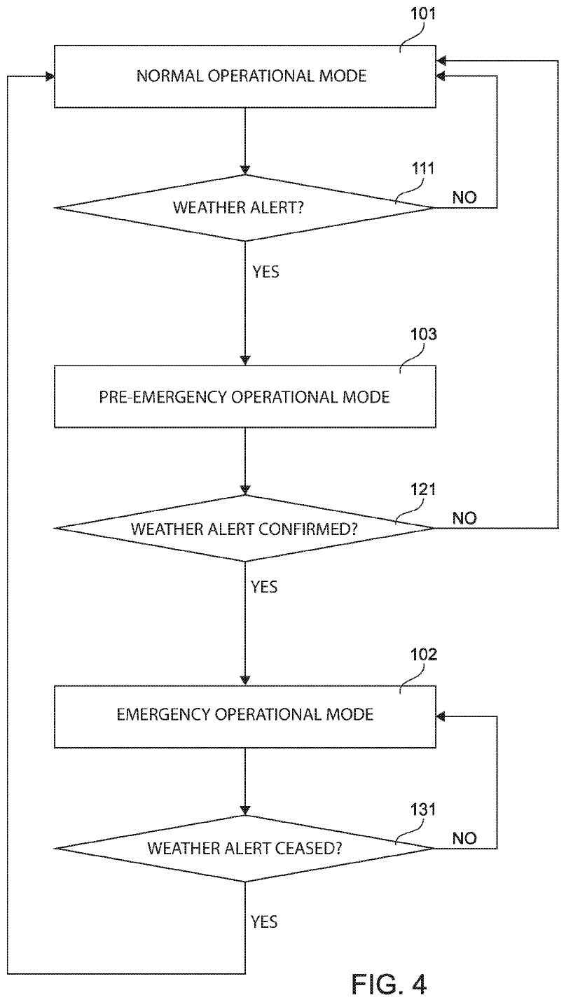

The plurality of operational modes (FIG. 4) comprises a first, normal, operational mode 101, wherein the wind turbine 3 is connected to the electrical grid 2, and a second, emergency, operational mode 102, wherein the wind turbine 3 is connected to the emergency power supply system 51.

Conveniently, in the first operational mode 101, the wind turbine 3 is connected to the electrical grid 2 and is not connected to the emergency power supply system 51. Conversely, in the second operational mode 102, the wind turbine 3 is connected to the emergency power supply system 51 and is not connected to the electrical grid 2.

Therefore, the first operational mode 101 can also be referred to as normal operational mode, since the wind turbine 3, being connected to the electrical grid 2, can operate normally. In particular, the wind turbine 3 in the first operational mode 101 can generate and deliver electrical energy to the electrical grid 2.

Conversely, the second operational mode 102 may also be referred to as emergency operational mode, since the wind turbine 3, being connected to the emergency power supply system 51, does not operate normally. In particular, the wind turbine 3 in the second operational mode 102 does not deliver electrical energy to the electrical grid 2, and is powered by the emergency power supply system 51.

Preferably, the plurality of operational modes comprises a third, pre-emergency, operational mode 103, wherein the wind turbine 3 is connected to the electrical grid 2 if a predetermined condition is met, and is connected to the emergency power supply system 51 otherwise, i.e. if the predetermined condition is not met.

Preferably, such predetermined condition is the presence of voltage on the electrical grid 2.

Preferably, such predetermined condition is detected by the aforementioned sensor configured to detect the presence of voltage on the electrical grid 2.

In particular, if in the third operational mode 103 voltage is present on the electrical grid 2, the wind turbine 3 is connected to the electrical grid 2 and is not connected to the emergency power supply system 51. Conversely, if in the third operational mode 103 no voltage is present on the electrical grid 2, the wind turbine 3 is connected to the emergency power supply system 51 and is not connected to the electrical grid 2.

Conveniently, in the third operational mode 103, the switching between the electrical grid 2 and the emergency power supply system 51 occurs automatically, on the basis of the presence of voltage on the electrical grid 2.

Preferably, in the third operational mode 103, the switching between the electrical grid 2 and the emergency power supply system 51 is implemented by the control unit 61, i.e. the control unit 61 is configured to switch between the electrical grid 2 and the emergency power supply system 51.

The third operational mode 103 may also be referred to as pre-emergency operational mode, as it occurs prior to the second, emergency, operational mode 102. In other words, if the wind turbine 3 is in the second, emergency, operational mode 102, it was previously in the third, pre-emergency, operational mode 103.

Preferably, the wind turbine 3 comprises a data receiving unit configured to receive signals relating to weather alerts emitted by data transmitting units, for example data transmitting units of weather agencies.

Preferably, the control unit 61 is coupled to the data receiving unit and is configured to receive, from the data receiving unit, the signals relating to the weather alerts.

Preferably, the switching from the first operational mode 101 to the third operational mode 103 occurs upon a weather alert 111.

In particular, if the wind turbine 3 is in the first operational mode 101 and a weather alert 111 is present, then the switching from the first operational mode 101 to the third operational mode 103 occurs. If the wind turbine 3 is in the first operational mode 101 and no weather alert 111 is present, then the wind turbine 3 remains in the first operational mode 101.

Conveniently, the weather alert 111 is an alert which is issued, typically by a weather agency, to indicate that the current weather conditions are favourable to the development of dangerous weather conditions in the future, although such dangerous weather conditions are not currently present.

In particular, the weather alert 111 is defined by the prediction of the arrival of a cyclonic event, which in turn depends on a value relating to the predicted and/or estimated wind for a predetermined future time interval, for example five days.

Preferably, the control unit 61 is configured to receive signals relating to the weather alert 111.

Preferably, the switching from the first operational mode 101 to the third operational mode 103 is implemented by the control unit 61, i.e. the control unit 61 is configured to switch from the first operational mode 101 to the third operational mode 103.

Conveniently, the switching from the first operational mode 101 to the third operational mode 103 occurs automatically, i.e. without human intervention, and/or manually, i.e. via human intervention (e.g. via push buttons or graphic control elements). In particular, such switching may occur automatically upon the weather alert 111, or be controlled manually, or be suggested automatically and validated manually.

Preferably, the switching from the third operational mode 103 to the second operational mode 102 occurs upon a weather alert confirmation 121.

In particular, if the wind turbine 3 is in the third operational mode 103 and a weather alert confirmation 121 is present, i.e. the weather alert is confirmed, then the switching from the third operational mode 103 to the second operational mode 102 occurs.

Conveniently, the weather alert confirmation 121 is issued, typically by a weather agency, to warn of approaching dangerous weather conditions. In other words, the weather alert confirmation 121 is issued when the dangerous weather conditions, which had been assumed with the issuance of the weather alert 111, are confirmed and imminent.

Preferably, the control unit 61 is configured to receive signals relating to the weather alert confirmation 121.

Preferably, the switching from the third operational mode 103 to the second operational mode 102 is implemented by the control unit 61, i.e. the control unit 61 is configured to switch from the third operational mode 103 to the second operational mode 102.

Conveniently, the switching from the third operational mode 103 to the second operational mode 102 occurs automatically, i.e. without human intervention, and/or manually, i.e. via human intervention (e.g. via push buttons or graphic control elements). In particular, such switching may occur automatically upon the weather alert confirmation 121, or be controlled manually, or be suggested automatically and validated manually.

Preferably, the third operational mode 103 lasts no longer than a predetermined time interval, for example two days. In other words, the maximum stay of the wind turbine 3 in the third operational mode 103 is equal to such predetermined time interval.

In particular, in the absence of the weather alert confirmation 121 during such predetermined time interval, the switching from the third operational mode 103 to the first operational mode 101 occurs. The absence of the weather alert confirmation 121 implies that the dangerous weather conditions, which had been assumed with the issuance of the weather alert 111, are not confirmed or imminent, i.e. the weather alert 111 has been withdrawn.

Therefore, immediately after the end of such predetermined time interval, the wind turbine 3 is in the second operational mode 102, if the weather alert has been confirmed during such predetermined time interval, or in the first operational mode 101, if the weather alert has not been confirmed during such predetermined time interval.

Conveniently, if the wind turbine 3 is in the third operational mode 103 and the weather alert is confirmed before the end of such predetermined time interval, the switching from the third operational mode 103 to the second operational mode 102 occurs as soon as possible after the weather alert confirmation 121, and thus before the end of such predetermined time interval.

Preferably, the switching from the second operational mode 102 to the first operational mode 101 occurs after a weather alert cessation 131.

In particular, if the wind turbine 3 is in the second operational mode 102 and a weather alert cessation 131 is present, i.e. the weather alert is no longer present, then the switching from the second operational mode 102 to the first operational mode 101 occurs, optionally after carrying out a maintenance of the wind power plant 1. If the wind turbine 3 is in the second operational mode 102 and no weather alert cessation 131 is present, i.e. the weather alert is still present, then the wind turbine 3 remains in the second operational mode 102.

Preferably, the control unit 61 is configured to receive signals relating to the weather alert cessation 131.

Preferably, the switching from the second operational mode 102 to the first operational mode 101 is implemented by the control unit 61, i.e. the control unit 61 is configured to switch from the second operational mode 102 to the first operational mode 101.

Conveniently, the switching from the second operational to the first operational mode 101 mode 102 occurs and/or automatically, i.e. without human intervention, manually, i.e. via human intervention (e.g. via push buttons or graphic control elements). In particular, such switching may occur automatically after the weather alert cessation 131, or be controlled manually, or be suggested automatically and validated manually.

Conveniently, the wind turbine 3 is controlled in a safe position in the second operational mode 102.

Indeed, the wind turbine 3 is in the second operational mode 102 upon the weather alert confirmation 121, i.e. when the dangerous weather conditions are imminent or in progress. Therefore, the wind turbine 3 is put and maintained in safety when in the second operational mode 102. For this purpose, the wind turbine 3 is powered by the emergency power supply system 51, in particular by the engine-generator.

In particular, if voltage was present on the electrical grid 2 when the wind turbine 3 was in the third operational mode 103, then the wind turbine 3 was connected to the electrical grid 2 and was not connected to the emergency power supply system 51. In such a case, the wind turbine 3 is disconnected from the electrical grid 2 and connected to the emergency power supply system 51 when the switching from the third operational mode 103 to the second operational mode 102 occurs.

Conversely, if no voltage was present on the electrical grid 2 when the wind turbine 3 was in the third operational mode 103, then the wind turbine 3 was connected to the emergency power supply system 51 and was not connected to the electrical grid 2. In this case, the wind turbine 3 is already connected to the emergency power supply system 51 when the switching from the third operational mode 103 to the second operational mode 102 occurs.

Preferably, controlling the wind turbine 3 in the safety position comprises controlling the blades 14 and/or the nacelle 12, as described in detail hereinafter.

Conveniently, when the wind turbine 3 is in the second operational mode 102, an angle of rotation of each blade 14 about the respective axis A3 is controlled. This angle is known as the pitch angle of the blade 14. Therefore, controlling the blades 14 implies controlling the pitch angle of each blade 14. In particular, the pitch angle of each blade 14 is controlled individually.

Conveniently, the pitch angles of the respective blades 14 are detected by the pitch sensors 31. Conveniently, the pitch sensors 31 are powered by the emergency power supply system 51 when the wind turbine 3 is in the second operational mode 102.

Conveniently, the angle of rotation of each blade 14 about the respective axis A3 is controlled so that each blade 14 is in a predetermined blade configuration when the wind turbine is in the second operational mode 102.

Preferably, each blade 14 is parallel to the airflow, i.e. to the wind direction, and with the wind primarily hitting on the leading edge in the predetermined blade configuration. This angular position of the blade with respect to the airflow is also referred to as feathered.

In other words, the pitch angle of each blade 14 is controlled so that the blade 14 is parallel to the airflow, i.e. the wind direction, and with the wind primarily hitting on the leading edge (and/or in feathered position) thus minimising the load due to the action of the wind on the blade 14.

In particular, the difference between the pitch angle of each blade 14 in the first operational mode 101 and the respective angle in the second operational mode 102 corresponds approximately to a rotation of 90°.

Preferably, in the second operational mode 102, the blades 14 are rotated about the respective axes A3 and kept parallel to the airflow and so that the wind primarily hits on the leading edge (and/or in feathered position) via the pitch actuators 41. In particular, in the second operational mode 102, the blades 14 are rotated about the respective axes A3 via the pitch drives and kept parallel to the airflow and so that the wind primarily hits on the leading edge (and/or in feathered position) via the pitch brakes. Conveniently, the pitch actuators 41 are powered by the emergency power supply system 51 when the wind turbine 3 is in the second operational mode 102.

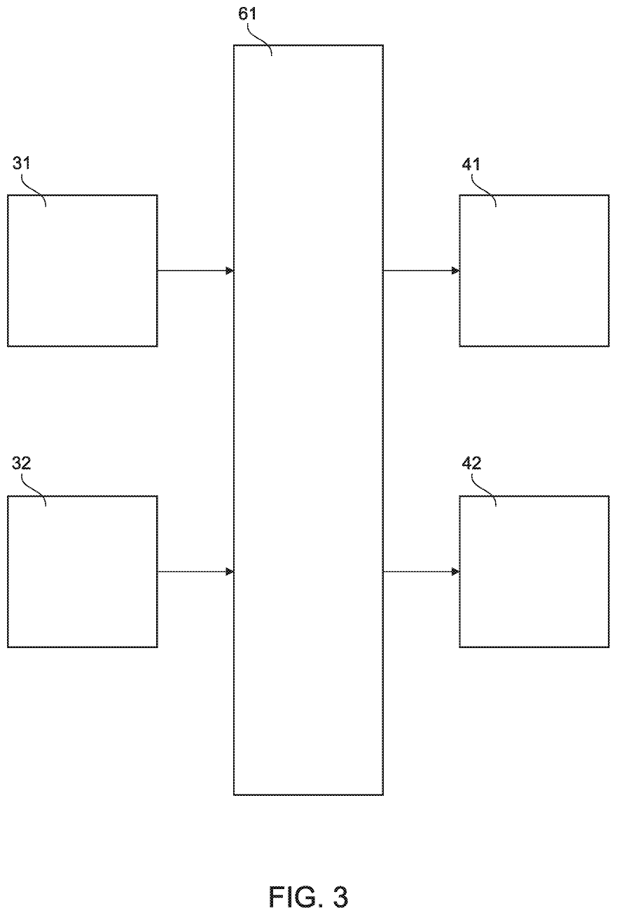

Conveniently, the control unit 61 (FIG. 3) is coupled to the pitch sensors 31 and the pitch actuators 41, and is configured to receive signals from the pitch sensors 31 and to control the pitch actuators 41 so that each blade 14 is in the predetermined blade configuration, preferably parallel to the airflow and so that the wind primarily hits on the leading edge (and/or in feathered position), when the wind turbine 3 is in the second operational mode.

Conveniently, when the wind turbine 3 is in the second operational mode 102, an angle of rotation of the nacelle 12 about the axis A1 is continuously controlled. This angle is known as the yaw angle of the nacelle 12. Therefore, controlling the nacelle 12 implies controlling the yaw angle of the nacelle 12.

Conveniently, the yaw angle of the nacelle 12 is detected by the yaw sensor 32. Conveniently, the yaw sensor 32 is powered by the emergency power supply system 51 when the wind turbine 3 is in the second operational mode 102.

Conveniently, the angle of rotation of the nacelle 12 is continuously controlled so that the nacelle 12 is in a nacelle configuration when the wind turbine is in the second operational mode 102.

Preferably, the nacelle 12 is downwind in the nacelle configuration.

In other words, the yaw angle of the nacelle 12 is continuously controlled so that the nacelle 12 is downwind, i.e. so that the wind strikes first the nacelle 12 and then the blades 14, thus minimising the loads on the wind turbine 3 due to the action of the wind on the blades 14.

In particular, the difference between the yaw angle of the nacelle 12 in the first operational mode 101 and the respective angle in the second operational mode 102 a corresponds approximately to rotation of 180°. Conveniently, the direction of such rotation is selected so as to minimise the twisting of cables present inside the support structure 11.

Preferably, in the second operational mode 102, the nacelle 12 is rotated about the axis A1 and held downwind by the yaw actuators 42. In particular, in the second operational mode 102, the nacelle 12 is rotated about the axis A1 via the yaw drives and held downwind via the yaw brakes. Conveniently, the yaw actuators 42 are powered by the emergency power supply system 51 when the wind turbine 3 is in the second operational mode 102.

Conveniently, the control unit 61 (FIG. 3) is coupled to the yaw sensor 32 and the yaw actuators 42, and is configured to receive signals from the yaw sensor 32 and to control the yaw actuators 42 so that the nacelle 12 is in the nacelle configuration, preferably downwind, when the wind turbine 3 is in the second operational mode.

For the sake of convenience, a reference angular position of each blade 14, corresponding to 0°, is defined when a reference wing chord of the blade 14 lies in a plane orthogonal to the axis of rotation of the rotor 23.

The reference wing chord of the blade 14 is defined by a chord joining a point of the leading edge 15 of the blade 14 with a point of the trailing edge 16 of the blade 14 and wherein such points belong to the same reference wing profile.

In other words, the angular reference position of each blade 14, corresponding to 0°, is such that the blade 14 is orthogonal to the wind direction, and the wind strikes a first side of the blade 14, also called the belly or lower profile of the blade 14, configured to be directly struck by the wind, allowing the wing surface of the blade 14 exposed to the wind to be maximised.

According to a first embodiment, in the second operational mode 102, the rotation of the nacelle 12 occurs subsequently to the rotations of the blades 14.

In particular, initially each blade 14 is rotated, up to a configuration corresponding to an angular position of −90° with respect to the reference angular position and preferably with respect to a reference rotation direction, so that it is parallel to the airflow and the wind strikes the respective trailing edge 16. Such angular position of the blade with respect to the airflow is also referred to as anti-feathered.

Subsequently, the nacelle 12 is rotated so that it is downwind.

Therefore, upon the rotation of the nacelle 12, each blade 14 is parallel to the airflow and the wind strikes the respective leading edge 15 (and/or in feathered position).

According to a second embodiment, in the second operational mode 102, the rotation of the nacelle 12 occurs prior to the rotations of the blades 14.

In particular, initially the nacelle 12 is rotated so that it is downwind.

Subsequently, each blade 14 is rotated, up to a configuration corresponding to an angular position of −90° with respect to the reference angular position and preferably with respect to the reference rotation direction, so that it is parallel to the airflow and the wind strikes the respective leading edge 15 (and/or in feathered position).

Therefore, the only difference between the first embodiment and the second embodiment is the order of the rotations of the nacelle 12 and of the blades 14.

However, in both embodiments the same effects are obtained, in particular the nacelle 12 is downwind and each blade 14 is “feathered”, i.e. it is parallel to the airflow and the wind strikes the respective leading edge 15.

According to a third embodiment, in the second operational mode 102, the rotation of the nacelle 12 occurs at least partially simultaneously with the rotations of the blades 14.

In particular, each blade 14 is rotated, up to a configuration corresponding to an angular position of −90° with respect to the reference angular position and preferably with respect to the reference rotation direction, and at least partially simultaneously the nacelle 12 is rotated so that it is downwind.

Therefore, upon the rotations of the nacelle 12 and of each blade 14, the nacelle 12 is downwind and each blade 14 is “feathered”, i.e. it is parallel to the airflow and the wind strikes the respective leading edge 15.

Conveniently, upon the switching from the second operational mode 102 to the first operational mode 101, the wind turbine 3 is controlled from the safety position to the aforementioned normal operating position.

In particular, the angle of rotation of each blade 14 about the respective axis A3 and/or the angle of rotation of the nacelle 12 is controlled. The control is dual to that described previously, i.e. the rotations of the blades 14 and/or of the nacelle 12 are opposite to those described previously. Preferably, the rotation of the nacelle 12 occurs subsequently to the rotations of the blades 14.

Conveniently, the emergency power supply system 51, in particular the engine-generator, is dimensioned to power the wind turbine 3 in the second operational mode 102 and, preferably, in the third operational mode 103. In particular, the maximum use of the emergency power supply system 51 in the third operational mode corresponds to the case wherein the wind turbine 3 is connected to the emergency power supply system 51 throughout the stay in the third operational mode 103 and this stay has a maximum duration, i.e. equal to the aforementioned predetermined time interval.

In view of the foregoing, the present invention also relates to a method for controlling a wind power plant 1 for generating and delivering electrical energy to an electrical grid 2, the wind power plant 1 comprising a wind turbine 3 configured to be selectively connected to the electrical grid 2, the method comprising controlling the wind turbine among a plurality of operational modes on the basis of different weather conditions.

In particular, the plurality of operational modes comprises the first operational mode 101, the second operational mode 102 and, preferably, the third operational mode 103 described previously.

Preferably, the method further comprises the step of receiving a weather alert 111 and switching from the first operational mode 101 to the third operational mode 103 upon the weather alert 111.

Preferably, the method further comprises the step of receiving a weather alert confirmation 121 and switching from the third operational mode 103 to the second operational mode 102 upon the weather alert confirmation 121.

Preferably, the method further comprises the step of switching from the third operational mode 103 to the first operational mode 101 in the absence of a weather alert confirmation 121 during a predetermined time interval.

Preferably, the method further comprises the step of receiving a weather alert cessation 131 and switching from the second operational mode 102 to the first operational mode 101 after the weather alert cessation 131.

Preferably, the method further comprises the step of controlling the wind turbine 3 in a safety position in the second operational mode 102.

In particular, the method comprises the step of controlling each blade 14 and/or the nacelle 12 when the wind turbine 3 is in the second operational mode 102.

Finally, it is clear that modifications and variants can be made to the wind power plant 1 and the control method without departing from the scope of protection defined by the claims.

The invention claimed is:

1-21. (canceled)

22. A method of controlling a wind power plant configured to generate and deliver electrical energy to an electrical grid, the method comprising controlling, based on different weather conditions and among a plurality of operational modes, a wind turbine selectively connectable to the electrical grid.

23. The method of claim 22, wherein the plurality of operational modes comprises a first operational mode in which the wind turbine is connected to the electrical grid and a second operational mode in which the wind turbine is connected to an emergency power supply system of the wind power plant.

24. The method of claim 23, wherein the plurality of operational modes comprises a third operational mode in which the wind turbine is: (i) connected to the electrical grid if a predetermined condition of a presence of voltage on the electrical grid is met, and (ii) connected to the emergency power supply system if the predetermined condition is not met.

25. The method of claim 24, further comprising receiving a weather alert and switching from the first operational mode to the third operational mode responsive to the receipt of the weather alert.

26. The method of claim 25, further comprising receiving a weather alert confirmation and switching from the third operational mode to the second operational mode responsive to the receipt of the weather alert confirmation.

27. The method of claim 25, wherein the weather alert is defined by at least one of a predicted value relating to wind for a predetermined future time interval and an estimated value relating to wind for the predetermined future time interval.

28. The method of claim 24, wherein the third operational mode lasts no longer than a predetermined time interval.

29. The method of claim 28, further comprising switching from the third operational mode to the first operational mode when no weather alert confirmation is received during the predetermined time interval.

30. The method of claim 23, further comprising receiving a weather alert cessation and switching from the second operational mode to the first operational mode after receipt of the weather alert cessation.

31. The method of claim 23, wherein the emergency power supply system comprises an engine-generator configured to power the wind turbine.

32. The method of claim 23, further comprising controlling the wind turbine to a safe position in the second operational mode.

33. The method of claim 32, further comprising controlling an angle of rotation of a blade of the wind turbine about an axis when the wind turbine is in the second operational mode.

34. The method of claim 33, wherein the wind turbine comprises a pitch sensor configured to detect rotations of the blade about the axis and a pitch actuator configured to modify the angle of rotation of the blade about the axis, and further comprising receiving a signal from the pitch sensor and controlling the pitch actuator such that the angle of rotation of the blade about the axis is in a predetermined blade configuration when the wind turbine is in the second operational mode.

35. The method of claim 32, wherein the wind turbine comprises a support structure and a nacelle carried by the support structure and rotatable with respect to the support structure about an axis, and further comprising controlling an angle of rotation of the nacelle about the axis when the wind turbine is in the second operational mode.

36. The method of claim 35, wherein the wind turbine comprises a yaw sensor configured to detect rotations of the nacelle about the axis and a plurality of yaw actuators configured to modify the angle of rotation of the nacelle about the axis, and further comprising receiving signals from the yaw sensor and controlling the plurality of yaw actuators such that the nacelle is in a downwind nacelle configuration when the wind turbine is in the second operational mode.

37. A wind power plant configured to generate and deliver electrical energy to an electrical grid, the wind power plant comprising:
a wind turbine selectively connectable to the electrical grid, and
a control unit configured to control, based on different weather conditions, the wind turbine among a plurality of operational modes.

38. The wind power plant of claim 37, further comprising an emergency power supply system wherein the plurality of operational modes comprises a first operational mode in which the wind turbine is connected to the electrical grid, and a second operational mode in which the wind turbine is connected to the emergency power supply system.

39. The wind power plant of claim 38, wherein the plurality of operational modes comprises a third operational mode in which the wind turbine is: (i) connected to the electrical grid responsive to a predetermined condition of a presence of voltage on the electrical grid being met, and (ii) connected to the emergency power supply system responsive to the predetermined condition not being met.

40. The wind power plant of claim 38, wherein the emergency power supply system comprises an engine-generator configured to power the wind turbine.

41. The wind power plant of claim 38, wherein:
the wind turbine comprises a plurality of blades, a plurality of pitch sensors configured to detect rotations of the respective blades about respective axes, and a plurality of pitch actuators configured to modify an angle of rotation of each blade about the respective axis, and
the control unit is coupled to the plurality of pitch sensors and the plurality of pitch actuators and configured to: receive signals from the pitch sensors and control the pitch actuators such that each blade is in a predetermined blade configuration when the wind turbine is in the second operational mode.

42. The wind power plant of claim 38, wherein:
the wind turbine comprises:
a support structure,
a nacelle carried by the support structure and rotatable with respect to the support structure about an axis,
a yaw sensor configured to detect rotations of the nacelle about the axis, and
a plurality of yaw actuators configured to modify an angle of rotation of the nacelle about the axis, and
the control unit is coupled to the yaw sensor and the plurality of yaw actuators, and configured to: receive signals from the yaw sensor and control the plurality of yaw actuators such that the nacelle is in a downwind nacelle configuration when the wind turbine is in the second operational mode.
